(19) United States
(12) Patent Application Publication
(10) Pub. No.: US 2008/0310766 A1
(43) Pub. Date: Dec. 18, 2008

(54) LINER WITH BLADDER

(76) Inventors: James Plunkett, Wareham, MA (US); Joseph Sullivan, Plymouth, MA (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/762,212

(22) Filed: Jun. 13, 2007

(51) Int. Cl. B65D 30/08; B65D 30/10; B67D 5/01; B65D 33/14; B65D 35/56

(52) U.S. Cl. 383/22; 222/105; 222/1; 383/109; 383/3; 383/11; 383/17; 383/24

(57) ABSTRACT

The present invention is a system for shipping and discharging contents. The system comprises a liner including a front portion, a rear portion, and first and second side portions, wherein the front, rear, and first and second side portions are sealed together to form a top panel, a bottom panel, a front panel, a rear panel, and two gusseted side panels. At least one opening is provided on one of the front portion, the rear portion, the first side portion, or the second side portion for receiving a fitting. A bladder including at least a front panel and a rear panel and an opening provided in at least one of the panels, wherein the opening is adapted to receive gas, and wherein the bladder is sealed to the top panel of the liner and the bottom panel of the liner.

### FIELD OF THE INVENTION

The present invention relates to flexible liners for use in bulk containers such as those used in flexible intermediate bulk container (“FIBC”) systems or bag-in-box container systems. More particularly, the present invention relates to discharging the contents of a flexible liner for use in a FIBC or bag-in-box container system.

### BACKGROUND OF THE INVENTION

In recent years a number of industries have adopted the FIBC or bag-in-box concept for storing and transporting fluid and particulate commodities in relatively large quantities. For example, the FIBC or bag-in-box concept has been employed for transporting in bulk such diverse products as vegetable oils, salad dressings, syrups, soy sauce, peanut butter, pharmaceuticals, talc, motor oil, industrial chemicals, detergents in liquid or powder form, and toiletry products or ingredients.

The FIBC concept is a bulk container system comprising a flexible liner in a flexible or semi-flexible bag. In one embodiment, a FIBC bag is made of a woven material (e.g., woven polymer, TYVEX®, canvas, wire mesh or net). The flexible liner is typically chemically resistant and impermeable to water and air and serves as the container for a selected commodity. The FIBC bag serves as a protective container for the liner and its contents. A FIBC bag is disclosed in U.S. Pat. No. 4,596,040 to LaFleur et al., which issued Jun. 17, 1986, and is hereby incorporated by reference in its entirety.

The bag-in-box concept comprises a flexible liner and a rigid or semi-rigid box. The flexible liner is typically chemically resistant and impermeable to water and air and serves as the container for a selected commodity. The box may be made of plywood or other wood materials, cardboard, fiberboard, metal, or plastic. The box serves as a protective container for the liner and its contents. A box for a bag-in-box system is disclosed in U.S. Pat. No. 6,533,122 to Plunkett, which issued Mar. 18, 2003, and is hereby incorporated by reference in its entirety. A bag for use in a bag-in-box system is disclosed in U.S. patent application Ser. No. 10/818,882, which was filed Apr. 6, 2004, is entitled “Bag With Flap For Bag-In-Box Container System” and is hereby incorporated by reference in its entirety. Reference is made to U.S. application Ser. No. 10/900,068, which is hereby incorporated by reference in its entirety.

The liner may be of any suitable configuration. For example, the liner may be generally shaped like a cube. It also can be configured so that a cross-section that is generally parallel to the top and bottom of the liner is square, rectangular, circular, or any other suitable geometry.

One consideration of the FIBC or bag-in-box mode of shipment of materials in bulk is that the outer container can be a non-returnable or one-way container. For example, where the outer container is a box for a bag-in-box system and is generally made of a corrugated fiberboard or the like, the box can be discarded after use. Alternatively, the box may consist of interlocking panels of metal, wood, or a stiff or rigid plastic material, in which case the box may be disassembled and returned to the shipper after the associated liner has been emptied of its contents.

Where the outer container is a bag for a FIBC system and is made of a low cost woven material, the bag can be discarded after use. Alternatively, where the material of the bag is more expensive, the bag may be collapsed and returned to the shipper after the associated liner has been emptied of its contents.

With respect to the FIBC and bag-in-box concepts as applied to bulk shipment of commodities, the plastic flexible liners have taken various forms. One common form is the so-called “pillow” type, which consists of at least two sheets of plastic film sealed together at their edges. Another common form is the six-sided flexible liners (e.g., liners that take the shape of a cube or rectangular parallelepiped when filled) made from a plurality of sheets of plastic film.

Liners for use with a FIBC or bag-in-box system typically include at least one drain fitting near the bottom of the liner whereby the liner's contents may be removed, at least one filler fitting near the top of the liner whereby the liner may be filled with its contents, or both. In embodiments of the liner with at least a drain fitting, the outer container (i.e., the bag of a FIBC system or the box of a bag-in-box system) is provided with a discharge opening near or at the bottom end of the outer container through which the liquid or particulate contents can be discharged from the liner via its drain fitting. The discharge opening of the outer container may be fitted with a drain fitting that mates with or accommodates the drain fitting of the liner. This mating arrangement between drain fittings of the liner and outer container assures that material discharged from the liner will be directed to the intended receiving facility. In embodiments of the liner with at least a filler fitting, the outer container usually comprises a cover or top panel that is removable to permit access to the liner and the filler fitting.

Liner contents sometimes remain within the liner despite efforts to discharge them through the drain fitting. The leftover contents are often discarded which generates waste and inefficiency. This problems arises in both pillow type and six-sided flexible liners. Therefore, there is a need in the art for an efficient system and method for discharging the contents of a liner.

### BRIEF SUMMARY OF THE INVENTION

A system for shipping and discharging contents of the present invention comprises: a liner including a front portion, a rear portion, and first and second side portions, wherein the front, rear, and first and second side portions are sealed together to form a top panel, a bottom panel, a front panel, a rear panel and two gusseted side panels. At least one opening being provided on one of the front portion, the rear portion, the first side portion, or the second side portion for inserting contents into the liner or, for example, receiving a fitting for permitting contents to be inserted into the liner. A bladder including at least a front panel and a rear panel, wherein the front and rear portions are sealed to each other. At least one opening is provided on one of the front panel or rear panel for inserting a gas (or a mixture of gasses such as air, or fluid, liquid, etc.) into the bladder or, for example, receiving a fitting for permitting a gas to be inserted into the bladder.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a top isometric view of one embodiment of a liner in its inflated or filled state in accordance with an embodiment of the present invention.

FIG. 2 is a plan view of the liner in FIG. 1 in a flattened, as-made condition, with a part of the liner broken away.

FIG. 3 is a bottom view of the same liner in its flattened, as-made condition, with a part of the liner broken away.

FIG. 4 is a cross sectional view taken along line 4-4 of FIG. 2.

FIG. 5 is a top isometric view of a liner in its inflated state with a bladder attached in accordance with another embodiment of the present invention.

FIG. 6 is a top view of the liner of FIG. 5.

FIG. 7 is an isometric view of a bladder in accordance with the embodiment in FIG. 5.

FIG. 8 is a view of the front panel of the bladder in FIG. 7 in its flattened, as-made condition.

FIG. 9 is a view of the rear panel of the bladder in FIG. 7 in its flattened, as-made condition.

FIG. 10 is a view of a side panel of the bladder in FIG. 7 in its flattened, non-gusseted condition.

FIG. 11 is a view of a side panel of the bladder in FIG. 7 in its flattened, non-gusseted condition.

FIG. 12 is a top isometric view of a liner in its inflated state with a bladder attached in accordance with a further embodiment of the present invention.

FIG. 13 is a top view of the liner of FIG. 12.

FIG. 14 is an isometric view of a bladder in accordance with the embodiment in FIG. 12.

FIG. 15 is a view of the front panel of the bladder in FIG. 14 in its flattened, as-made condition.

FIG. 16 is a view of the rear panel of the bladder in FIG. 14 in its flattened, as-made condition.

FIG. 17 is side view of a liner and a bladder in a box.

FIG. 18 is side view of a liner and a bladder in a box.

FIG. 19 is side view of a liner and a bladder in a box.

FIG. 20 is side view of a liner and a bladder in a box.

FIG. 21 is side view of a liner and a bladder in a box.

### DETAILED DESCRIPTION

The present invention is directed to a flexible air assist liner and a bladder for use in bulk containers such as those used in flexible intermediate bulk container (“FIBC”) systems or bag-in-box container systems. While certain liner embodiments are discussed herein, the particular liner configuration is generally not important to the present invention, and instead, any suitable liner configuration may be used, such as a pillow-style liner. For illustration purposes only, a six-sided flexible liner is now discussed more fully. The six-sided liner may comprise a front portion, a rear portion, and first and second side portions. The front portion, rear portion, and side portions may be sealed together to form a front panel, a rear panel, two gusseted side panels, a top panel, and a bottom panel. More specifically, longitudinal edges of the front portion and the rear portion may be sealed to respective edges of the side portions. The first and second side portions may be folded to form gussets. Top ends of the front portion and the rear portion may be sealed to top folds of the first and second side portions, and bottom ends of the front portion and the rear portion may be sealed to bottom folds of the first and second side portions. An opening may be provided for inserting contents into the liner. Optionally, a removable piece may be provided in at least one of the portions for providing an opening to receive a fitment. The terms fitment and fitting are used interchangeably herein. After the portions are sealed together, the removable piece may be removed to provide an opening, and a fitment can be fit and sealed within the opening.

A bladder may be attached to at least one of the portions of the liner for discharging the contents of the liner. In one embodiment, the bladder may have a front portion, a rear portion, and two gusseted side portions, e.g., a six-sided bladder. Longitudinal edges of the front portion and the rear portion may be sealed to respective edges of the gusseted side portions. The first and second side portions may be folded to form gussets. The top ends of the first side portion and second side portion may be sealed to the top ends of the front and rear portion, and bottom ends of the first side portion and second side portion may be sealed to the bottom ends of the front portion and rear portion. An opening or fitting may provided on one of the portions of the bladder.

In alternative embodiments, other styles of bladders may be used. For example, a pillow-style bladder may be used. One embodiment of a pillow-style bladder may comprise a front panel and a rear panel. The front panel and the rear panel may be sealed together. At least one opening may be provided on the front or rear panel for inserting a gas (or a mixture of gasses such as air, or fluid, liquid, etc.) into the bladder. In another embodiment, the opening may receive a fitting through which a gas may be inserted into the bladder. In yet other embodiments, the bladder may comprise other fixtures or means for permitting gas to be inserted into the bladder, such as a tube into a chimney.

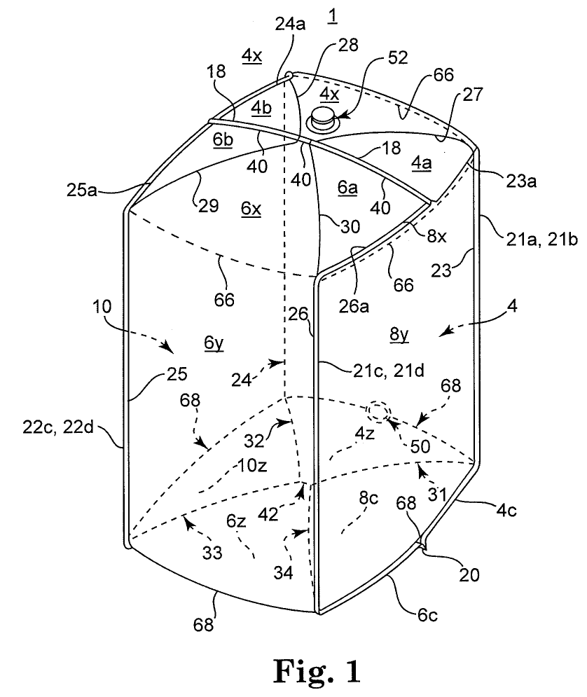

FIG. 1 is a top isometric view of a one embodiment of a standard liner 1 in its inflated or filled state. As indicated in FIG. 1, in one embodiment, the liner 1 may be a four side-seal type liner 1 (i.e., a liner having four longitudinal side-seals 23, 24, 25, 26) composed of four discrete portions (i.e., a front portion 4, a rear portion 6, and two side portions 8, 10) of flexible, heat-sealable packaging material in sheet form. The front portion 4, rear portion 6, and side portions 8, 10 may also be referred to as a front panel 4, rear panel 6, and side panels 8, 10. The side panels 8, 10 may be referred to as gusseted sides. By way of example but not limitation, the packaging sheet material may consist of polyethylene or polypropylene or some other thermoplastic material or be a laminate of two or more packaging materials bonded to one another. Each of the portions 4-10 may comprise a single sheet of packaging material (“single ply”) or two or more sheets of packaging material (“multi-ply”). In the case of multi-ply portions, the individual sheets ('plies”) may be of like or different material and may be secured to one another only in selected areas (e.g., at seals 23, 24, 25, 26, and other such seals as discussed in this detailed description).

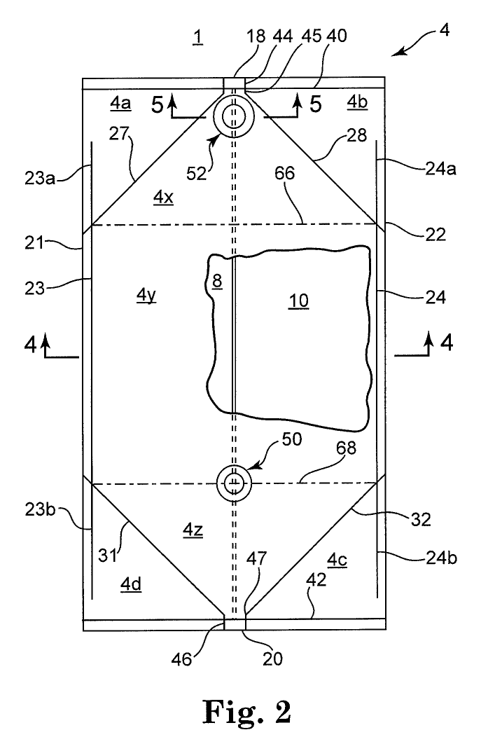

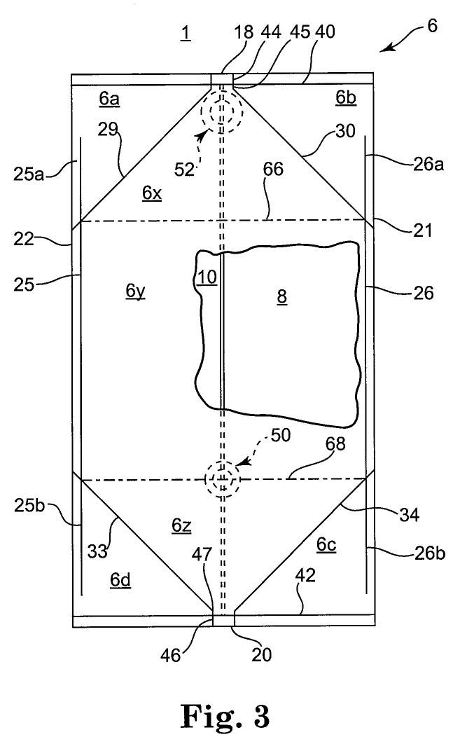

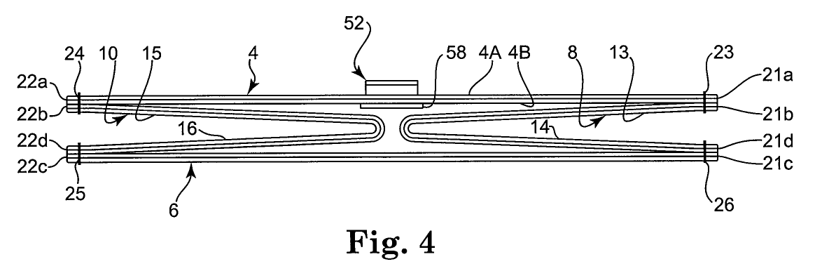

For a discussion of the liner 1 in its flat, as-formed condition, reference is made to FIGS. 2-4. FIG. 2 is a plan view of the liner 1 in its flattened, as-made condition, with part of the front portion 4 broken away to reveal the side portions 8, 10 below. FIG. 3 is a bottom view of the liner 1 in its flattened, as-made condition, with part of the rear portion 6 broken away to reveal the side portions 8, 10 above. FIG. 4 is a cross sectional view of the liner 1 taken along line 4-4 of FIG. 2. As shown in FIGS. 2-4, the front portion 4 and the rear portion 6 may be opposed to one another, and the side portions 8, 10 may be interposed between the front portion 4 and the rear portion 6. As best illustrated in FIG. 4, the side portions 8, 10 may be folded inwardly on themselves to form gussets 13, 14 and 15, 16, respectively.

As indicated in FIGS. 2 and 3, when the liner 1 is in the flattened, as-made condition, the front portion 4 and the rear portion 6 may have a generally rectangular configuration defined by a top edge 18, a bottom edge 20, and two side edges 21, 22. During manufacture, the four portions 4-10 can be cut from parallel elongate supply webs of packaging material. The side portions 8, 10 may be folded and inserted between the front portion 4 and the rear portion 6 before the four portions 4-10 are cut from the supply webs. As used herein and where the context so admits, the term “web” is to be understood as a single continuous sheet or two or more sheets that are brought together to form a multi-ply portion of a liner. Alternatively, as used herein, the term “web” is to be understood as a tubular film that is equivalent to two sheets that are brought together to form a multiply portion of a liner.

As shown in FIGS. 2 and 4, the front portion 4 may be sealed via longitudinal seal lines 23, 24 along its two longitudinally extending side edges 21a, 22a to the adjacent side edges 21b, 22b of the gussets 13, 15 of the respective side portions 8, 10. As indicated in FIGS. 3 and 4, the rear portion 6 may be sealed via longitudinal seal lines 25, 26 along its two longitudinally extending side edges 21c, 22c to the adjacent side edges 21d, 22d of the gussets 14, 16 of the respective side portions 8, 10.

As illustrated in FIGS. 2 and 3, adjacent the top end of the liner 1, two oblique seals 27, 28 may secure the front portion 4 to the gussets 13, 15, and another two oblique seals 29, 30 may secure the rear portion 6 to the gussets 14, 16. Adjacent the bottom end of the liner 1, two oblique seals 31, 32 may secure the front portion 4 to the gussets 13, 15, and another two oblique seals 33, 34 may secure the rear portion 6 to the gussets 14, 16.

As shown in FIGS. 2 and 3, in one embodiment, the oblique seals 27, 28, 31, 32 may extend through the longitudinal seals 23, 24, while the other oblique seals 29, 30, 33, 34 may extend through the other longitudinal seals 25, 26. In other embodiments, the oblique seals 27-34 may stop at their respective intersections with the longitudinal seals 23-26. The precise configuration of the seals is not central to the present invention.

Each of the oblique seals 27-34 may be provided using an automated sealer, for example, an automated press sealer. Each of the oblique seals 27-34 may be provided prior to, or after, provision of a fitting in the top portion (formed by top triangular sections 4x and 6x, rear top corner sections 6a and 6b, and front top corner sections 4a and 4b, discussed more fully below) or the bottom portion (formed by bottom triangular sections 4z and 6z, rear bottom corner sections 6c and 6d, and front bottom corner sections 4c and 4d, discussed more fully below).

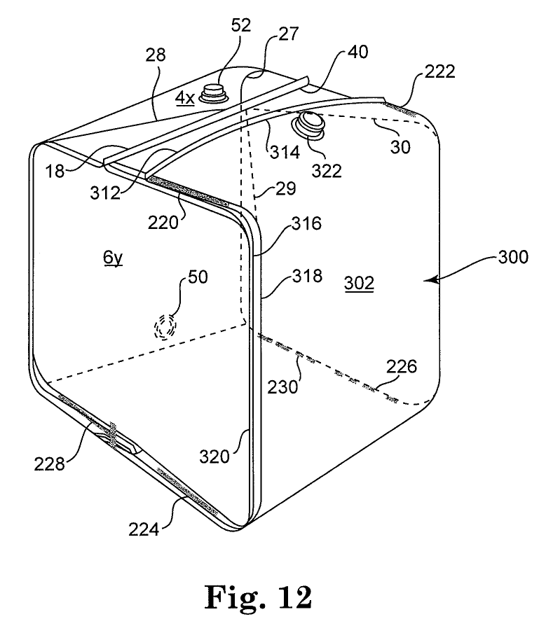

In one embodiment, at the top end of the liner 1, a cross seal 40 may extend laterally across the front and rear portions 4, 6 adjacent and parallel to the top edge 18. The top cross seal 40 may seal the front and rear portions 4, 6 together along the length of the top cross seal 40. The top oblique seals 27-30 may extend from their intersections with their respective longitudinal seals 23-26 towards the top cross seal 40. Just prior to intersecting the top cross seal 40, each top oblique seal 27-30 may curve from an oblique orientation to an orientation that is generally parallel to the longitudinal seals 23-26, thereby forming a short segment 44 with a curve 45 for each oblique seal 27-30 that extends through the top cross seal 40. In other embodiments, the oblique seals 27-30 may be linear, as can be seen in FIG. 12.

As shown in FIGS. 2 and 3, at the bottom end of the liner 1, a cross seal 42 may extend laterally across the front and rear portions 4, 6 adjacent and parallel to the bottom edge 20. The bottom cross seal 42 may seal the front and rear portions 4, 6 together along the length of the bottom cross seal 42. The bottom oblique seals 31-34 may extend from their intersections with their respective longitudinal seals 23-26 towards the bottom cross seal 42. Just prior to intersecting the bottom cross seal 42, each bottom oblique seal 31-34 may curve from an oblique orientation to an orientation that is generally parallel to the longitudinal seals 23-26, thereby forming a short segment 46 with a curve 47 for each oblique seal 31-34 that extends through the bottom cross seal 42. In other embodiments, the oblique seals 31-34 may be linear.

In manufacturing the liner 1, the cross seals 40, 42 may require a greater temperature/pressure as compared to those used to make the longitudinal side seals 23-26 and the oblique seals 27-34. This is because, in one embodiment, the cross seals 40, 42 may utilize more, such as twice as many, layers as the side and oblique seals 23-34. For example, referring to the upper right hand corner of FIG. 2, oblique seal 28 and longitudinal side seal 24 may each be formed by sealing front portion 4 and side portion 10 together. In contrast, cross seal 40 may be formed by sealing together front portion 4, rear portion 6, and portion 10 folded over on itself (i.e., two layers of portion 10 are sealed together with the front and rear portions 4, 6).

As illustrated in FIGS. 2 and 3, the front and rear portions 4, 6 each may have a generally hexagonal configuration (as defined by their respective longitudinal side seals 23-26 and oblique seals 27-34), except for being truncated at the upper most point by the top cross seal 40 and at the bottom most point by the bottom cross seal 42. As can be understood from FIG. 1, the side portions 8, 10 also may each have a generally hexagonal configuration (as defined by their respective longitudinal side seals 23-26 and oblique seals 27-34) when fully spread out flat. However, as can be understood from FIG. 1, unlike the front and rear portions 4, 6, the upper and lower most points of the side portions 8, 10 may not be truncated.

As can be understood from FIGS. 1-3, the hexagonal configuration of each portion 4-10 can be divided into three parts, which are a top triangular section 4x, 6x, 8x, 10x, a rectangular section 4y, 6y, 8y, 10y, and a bottom triangular section 4z, 6z, 8z, 10z. The top triangular sections 4x, 6x, 8x, 10x may be defined by the top oblique seals 27-30 and top fold lines 66 that run parallel to the top cross seal 40 and intersect the intersections between the top oblique seals 27-30 and the longitudinal side seals 23-26. Similarly, the bottom triangular sections 4z, 6z, 8z, 10z may be defined by the bottom oblique seals 31-34 and bottom fold lines 68 that run parallel to the bottom cross seal 42 and intersect the intersections between the bottom oblique seals 31-34 and the longitudinal side seals 23-26. The rectangular sections 4y, 6y, 8y, 10y may be defined by the longitudinal side seals 23-26 and the top and bottom fold lines 66, 68.

As can be understood from FIG. 1, when the liner 1 is inflated or filled, the top triangular sections 4x, 6x, 8x, 10x may fold toward each other about their respective top fold lines 66 to form the roof of the cubical liner 1, the bottom triangular sections 4z, 6z, 8z, 10z may fold toward each other about their respective bottom fold lines 68 to form the floor of the cubical liner 1, and the rectangular sections 4y, 6y, 8y, 10y may fold about their respective longitudinal side seals 23-26 to form the sidewalls of the cubical liner 1.

As indicated in FIG. 2, the top oblique seals 27, 28, the top cross seal 40, and the side seals 23, 24 may generally define front top corner sections 4a, 4b out of the front portion 4. In one embodiment, each front top corner section 4a, 4b may further include corresponding areas of the side portions 8, 10 that are defined by the top oblique seals 27, 28, the top cross seal 40, and the side seals 23, 24.

As shown in FIG. 3, the top oblique seals 29, 30, the top cross seal 40, and the side seals 25, 26 may generally define rear top corner sections 6a, 6b out of the rear portion 6. In one embodiment, each rear top corner section 6a, 6b may further include corresponding areas of the side portions 8, 10 that are defined by the top oblique seals 29, 30, the top cross seal 40, and the side seals 25, 26.

As illustrated in FIG. 1, because the front top corner sections 4a, 4b may be sealed to the rear top corner sections 6a, 6b by the top cross seal 40, when the liner 1 is inflated or filled and takes its form, the top corner sections 4a, 6a may extend across the top triangular section 8x and the top corner sections 4b, 6b may extend across the top triangular section 10x.

For a continued discussion of the general configuration of one embodiment of the liner 1, reference is again made to FIGS. 1-3. As indicated in FIG. 2, the bottom oblique seals 31, 32, the bottom cross seal 42, and the side seals 23, 24 may generally define front bottom corner sections 4c, 4d out of the front portion 4. In one embodiment, each front bottom corner section 4c, 4d may further include corresponding areas of the side portions 8, 10 that are defined by the bottom oblique seals 31, 32, the bottom cross seal 42, and the side seals 23, 24.

As shown in FIG. 3, the bottom oblique seals 33, 34, the bottom cross seal 42, and the side seals 25, 26 may generally define rear bottom corner sections 6c, 6d out of the rear portion 6. In one embodiment, each rear bottom corner section 6c, 6d may further include corresponding areas of the side portions 8, 10 that are defined by the bottom oblique seals 33, 34, the bottom cross seal 42, and the side seals 25, 26.

As can be understood from FIG. 1, because the front bottom corner sections 4c, 4d may be sealed to the rear bottom corner sections 6c, 6d by the bottom cross seal 42, when the liner 1 is inflated or filled and takes its cubical form, the bottom corner sections 4c, 6c may extend across the bottom triangular section 8z and the bottom corner sections 4d, 6d may extend across the bottom triangular section 10z.

As indicated in FIGS. 2 and 3, each longitudinal side seal 23-26 may have a segment that extends across the respective bottom oblique seal 31-34 into the respective bottom corner section 4c, 4d, 6c, 6d. In one embodiment, as shown in FIGS. 2 and 3, these bottom segments 23b, 24b, 25b, 26b may run from the intersection of the respective oblique seal 31-34 and side seal 23-26 to a point nearly intersecting the bottom cross seal 42. In other embodiments, the bottom segments 23b, 24b, 25b, 26b may have a greater or lesser length. In one embodiment, each longitudinal side seal 23-26 may stop at its intersection with the respective bottom oblique seal 31-34 such that there are no bottom segments 23b, 24b, 25b, 26b.

For a discussion of the location of the optional fill and drain fittings of the liner 1, reference is now made to FIG. 1. Reference is made to “openings” 50 and 52. It is to be understood that the openings 50, 52 may comprise removable pieces, may comprise thru holes, for example, where the removable pieces have been removed, may comprise an opening having a fitting fit therein, etc. FIG. 1 illustrates a fitment provided in opening 50. Openings 50, 52 may be a drain opening or a fill opening.

As can be understood from FIG. 1, when inflated or filled, the liner 1 may be self-supporting in the sense that it tends to remain erect and not fall over when its bottom end is resting on a flat floor or platform. When an un-inflated liner 1 is inserted in an outside container, the flexibility of the un-inflated liner 1 may allow the fitment 50 to be properly positioned in any commodity discharge opening provided in the bottom of the outside container. Once so positioned, the cap of the fitment 50 may be removed to initiate the liner-emptying process for an inflated or filled liner 1.

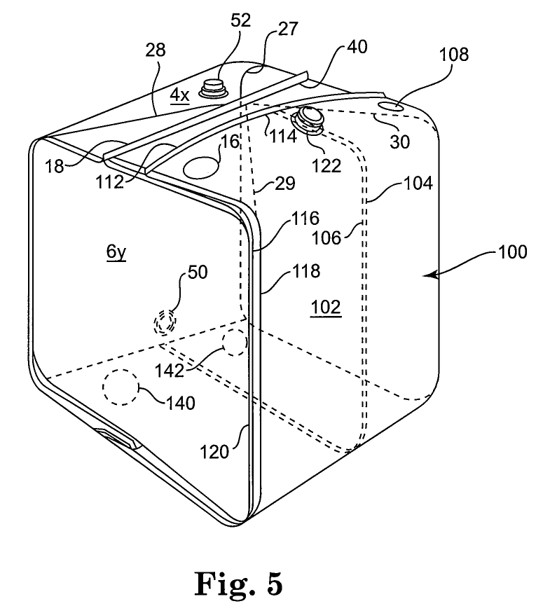

As previously explained, the flexibility of the material comprising the four portions 4-10 may cause a liner 1 to tend to collapse at its upper portion when the liner 1 is being emptied of its contents via the fitment 50. Such a collapsing of the liner 1 may make it difficult to completely empty the liner 1 of viscous contents such as peanut butter, industrial oil, or the like. Therefore, as shown in FIG. 5, a bladder 100 may be used in conjunction with the liner in order to discharge the contents of the liner 1. The bladder 100 can be used for any type of liner, such as a pillow-style liner, a six-sided liner, etc., and can be attached to the liner or formed as part of the liner, for example, where the liner and the bladder have abutting panels forming a common panel.

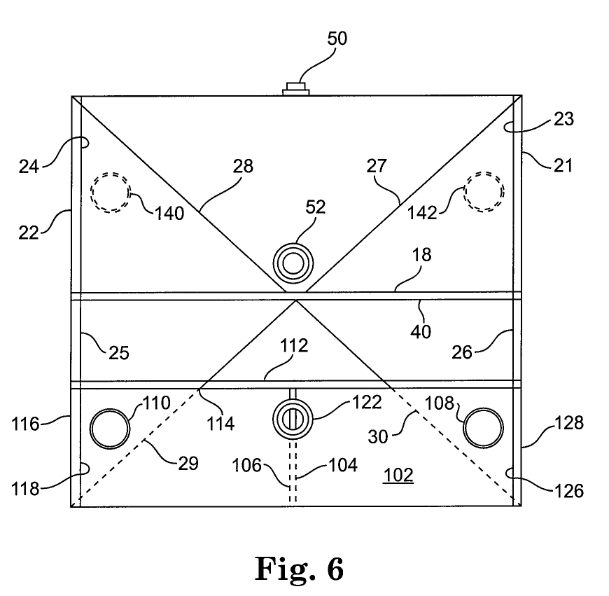

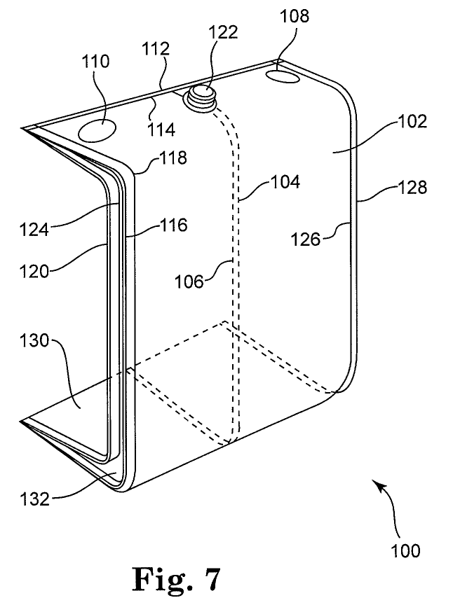

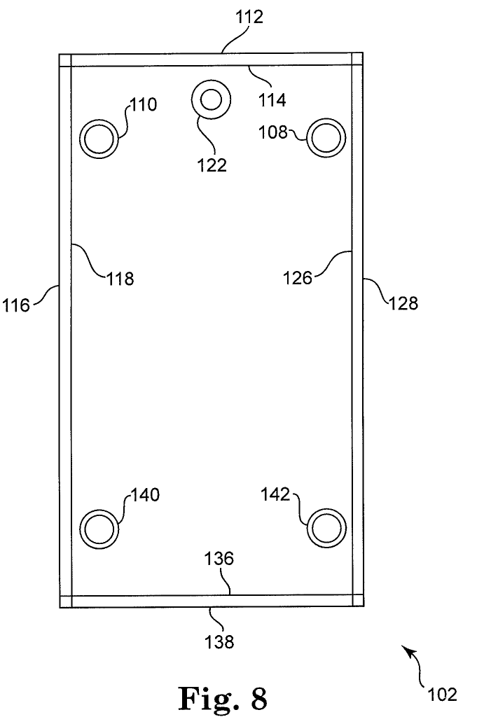

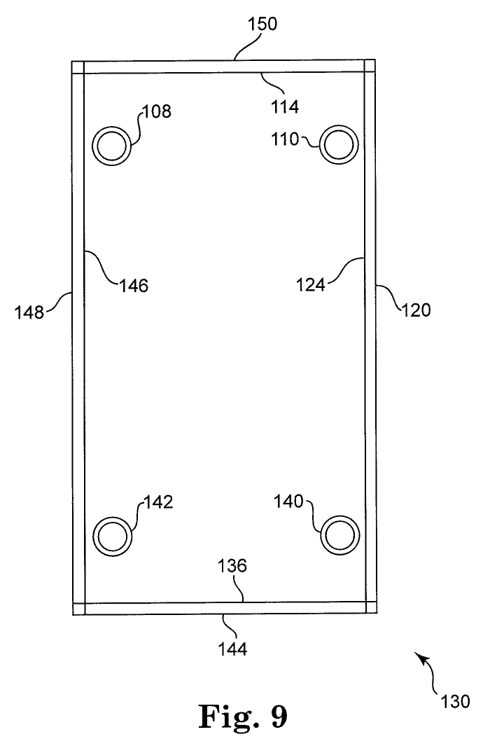

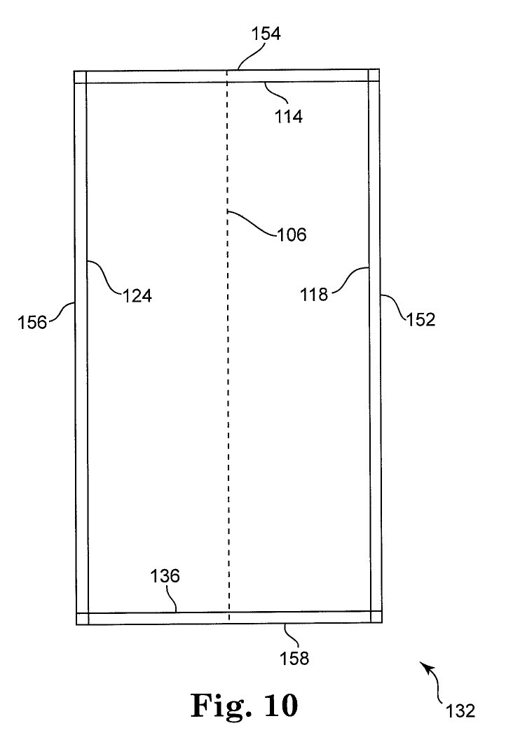

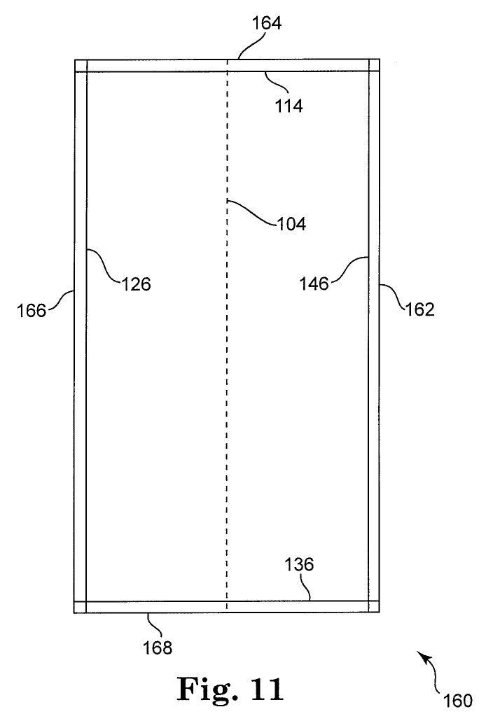

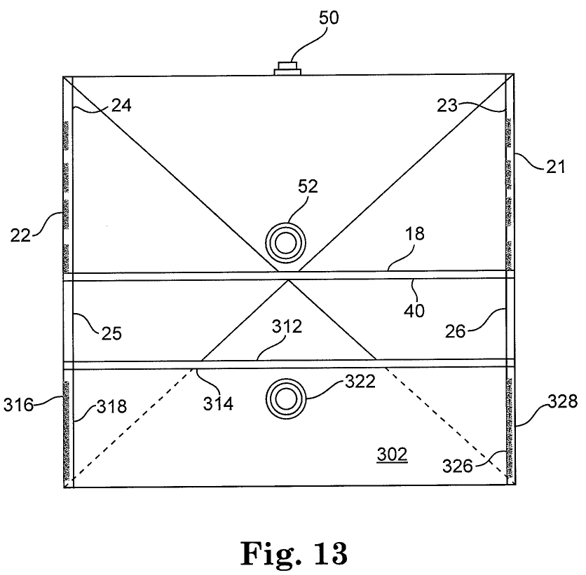

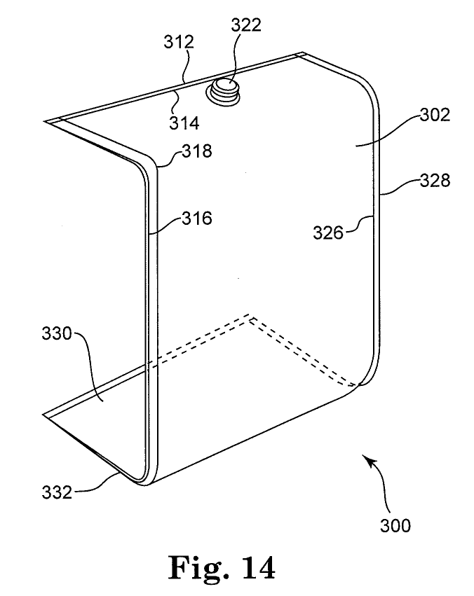

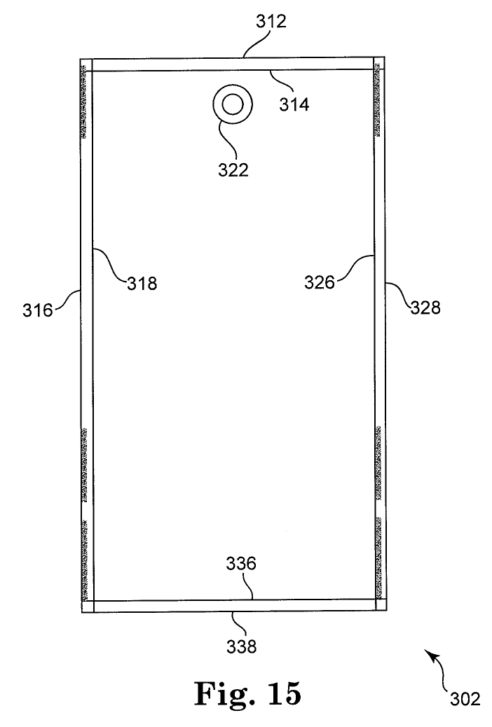

For a discussion of the bladder, reference is now made to FIGS. 5-15. FIG. 5 is a top isometric view of a liner in its inflated state with a bladder 100 attached. FIG. 6 is a top view of FIG. 5. FIG. 7 is an isometric view of the bladder 100 in FIG. 5. FIG. 8 is a view of a front panel 102 of the bladder 100 in FIG. 7 in its flattened, as-made condition. FIG. 9 is a view of a rear panel 130 of the bladder 100 in FIG. 7 in its flattened, as-made condition. FIG. 10 is a view of a side panel 132 of the bladder in FIG. 7 in its flattened, non-gusseted condition. FIG. 11 is a view of a side panel 160 of the bladder in FIG. 7 in its flattened, non-gusseted condition. FIG. 12 is a top isometric view of a liner in its inflated state with another embodiment of a bladder 300 attached. FIG. 13 is a top view of FIG. 12. FIG. 14 is an isometric view of the bladder 300 in FIG. 12. FIG. 15 is a view of a front panel 302 of the bladder 300 in FIG. 14 in its flattened, as-made condition.

Bladder 100 in FIG. 5 may have a front panel 102, a rear panel 130, and side panels 132, 160. As shown in FIGS. 5-11, the front panel 102 and the rear panel 130 may be opposed to one another, and the side panels 132, 160 may be interposed between the front panel 102 and the rear panel 130. As best illustrated in FIG. 5, the side panels 132, 160 may be folded inwardly on themselves along fold lines 106, 104 respectively to form gussets.

Front panel 102 may have a top edge 112, a bottom edge 138, and longitudinal side edges 116 and 128. Rear panel 130 may have a top edge 150, a bottom edge 144, and longitudinal side edges 148 and 120. Side panel 132 may have a top edge 154, a bottom edge 158, and longitudinal side edges 156 and 152. Side panel 160 may have a top edge 164, a bottom edge 168, and longitudinal side edges 166 and 162. As stated above, when forming bladder 100, side panel 132 may be folded inwardly on itself along fold 106 and side panel 160 may be folded inwardly on itself along fold 104. The folded top end 154 of side panel 132 may be connected to the top end 112 of front panel 102 and top end 150 of rear panel 130 by a seal 114. The folded top end 164 of side panel 160 may be connected to the top end 112 of front panel 102 and top end 150 of rear panel 130 by the seal 114. Seal 114 may be substantially parallel to the top end 112 of front panel 102 and top end 150 of rear panel 130 and may connect the front panel 102 and rear panel 130 together.

The folded bottom end 158 of side panel 132 may be connected to the bottom end 138 of front panel 102 and bottom end 144 of rear panel 130 by a seal 136. The folded bottom end 168 of side panel 160 may be connected to the bottom end 138 of front panel 102 and bottom end 144 of rear panel 130 by the seal 136. Seal 136 may be substantially parallel to the bottom end 138 of front panel 102 and bottom end 144 of rear panel 130 and may connect them together. As shown in FIGS. 5-7, the side panels 132 and 160 may not be connected together at their top ends 154, 164 or at their bottom ends 158, 168 but instead may be separated by a distance. In other embodiments, the side seals 132 and 160 may be connected together at their top ends 154, 164 and their bottom ends 158, 168, by seals 114 and 136, respectively.

The longitudinal side edge 152 of side panel 132 may be connected to the longitudinal side edge 116 of front panel 102 by a seal 118 that runs substantially parallel to longitudinal side edges 152, 116. The longitudinal side edge 156 of side panel 132 may be connected to the longitudinal side edge 120 of rear panel 130 by a seal 124 that runs substantially parallel to longitudinal side edges 156, 120.

The longitudinal side edge 166 of side panel 160 may be connected to the longitudinal side edge 128 of front panel 102 by a seal 126 that runs substantially parallel to longitudinal side edges 166, 128. The longitudinal side edge 162 of side panel 160 may be connected to the longitudinal side edge 148 of rear panel 130 by a seal 146 that runs substantially parallel to longitudinal side edges 162, 148.

As shown in FIG. 6, the front panel 102 may have an opening 122. Opening 122 may comprise optional removable pieces, may comprise thru holes, for example, where the removable pieces have been removed, may comprise an opening having a fitting fit therein, etc. FIG. 5 illustrates a fitment provided in opening 122. In a further embodiment, the fitment may allow gas to be introduced into the bladder 102, through opening 122. Opening 122 may be located anywhere on front panel 102 and may be provided on other panels of the bladder 100. In other embodiments, the front panel 102 may have any other fixture or means for permitting gas (or a mixture of gasses such as air, or fluid, liquid, etc.) to be introduced into the bladder 100, such as a tube into a chimney.

As shown in FIG. 5, bladder 100 may be attached to the liner 1. As stated above, the bladder 100 and liner 1 may have abutting panels thereby forming a shared common panel. In other embodiments, the bladder 100 may be external to the liner 1 and have no abutting or common panels. As illustrated in FIG. 5, bladder 100 may be attached to liner 1 by seals 108, 110, 140, 142. Though four circular seals are illustrated, any number of seals may be used as well as any type (lateral, longitudinal, oblique, circular, etc.). Also, when bladder 100 shares a common panel with liner 1, no seals or means of attachment may be necessary.

In this example, seal 110 may attach front panel 102, rear panel 130, and side panel 132 of bladder 100 to rear top corner section 6b of liner 1. Likewise, seal 108 may attach front panel 102, rear panel 130, and side panel 160 of bladder 100 to rear top corner section 6a of liner 1. Furthermore, seal 140 may attach front panel 102, rear panel 130, and side panel 132 of bladder 100 to front bottom corner section 4c of liner 1. Seal 142 may attach front panel 102, rear panel 130, and side panel 160 of bladder 100 to front bottom corner section 4d of liner 1. In one embodiment, seals 108, 110, 140, and 142 may not seal through both the gussets formed by a side wall, e.g., 13 and 14 or 15 and 16, of the liner 1. That is, in some embodiments, seals 108 and 110 may only seal the bladder 100 to corner sections 6a and 6b, respectively. Similarly, seals 140 and 142 may only seal the bladder 100 to corner sections 4c and 4d, respectively.

Although the seals for the liner 1 and bladder 100 are illustrated by single lines, it is to be understood that the seals may vary in width and, for example, may extend out to the edges of the various portions and panels.

In the examples shown in FIGS. 5-11, the bladder 100 may be constructed so that the bladder covers substantially the entire bottom panel and rear panel and a portion of the top panel of liner 1. In other embodiments, the bladder may cover any number of panels and may cover any amount of a panel (e.g., completely cover a panel or only a portion of a panel). For example, in the case of a pillow-style liner that is made of only two panels, the bladder may be constructed to cover both of the panels or only one of the panels. In the case of six-sided flexible liners such as liner 1 shown in FIG. 1, at least a portion of the bladder 100 may lie underneath the liner 1 in order to elevate the liner 1 to aid in the discharge of contents. It is to be understood that the bladder may be any suitable size, configuration, and orientation. It may be bigger than the liner, generally the same size as the liner, smaller than the liner, overlapping, etc.

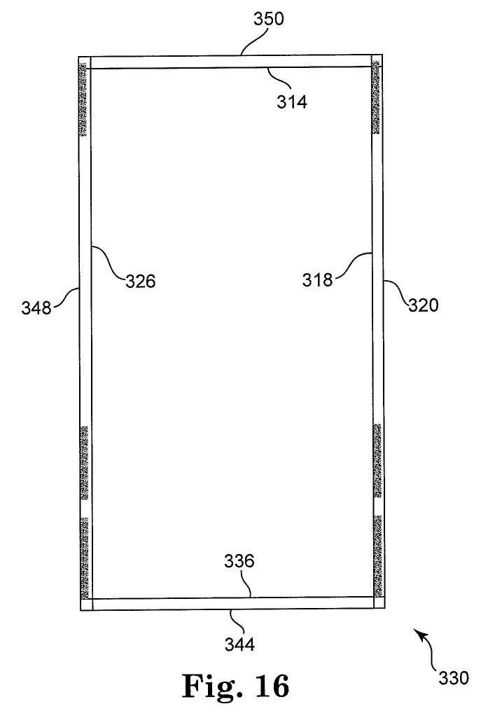

In another embodiment of the bladder 300, reference is made to FIGS. 12-16, wherein a pillow-style bladder is generally illustrated. As shown in FIG. 12, the bladder 300 may have a front panel 302 and a rear panel 330. As shown in FIGS. 12-16, the front panel 302 and the rear panel 330 may be opposed to one another and sealed around the perimeter of the panels at seals 314, 318, 326, and 336, forming a pillow-style bladder.

Front panel 302 may have a top edge 312, a bottom edge 338, and longitudinal side edges 316 and 328. Rear panel 330 may have a top edge 350, a bottom edge 344, and longitudinal side edges 320 and 348. As stated above, when forming bladder 300, seal 314 may be substantially parallel to the top edge 312 of front panel 302 and top edge 350 of rear panel 330 and may connect the front panel 302 and rear panel 330 together. Seal 336 may be substantially parallel to the bottom edge 338 of front panel 302 and bottom edge 344 of rear panel 330 and may connect the front panel 302 and rear panel 330 together. Seals 318 and 326 may be substantially parallel to the longitudinal side edges 316 and 328 of front panel 302 and longitudinal side edges 320 and 348 of rear panel 330, respectively, and may connect the front panel 302 and rear panel 330 together.

As shown in FIG. 13, the front panel 302 may have an opening 322. Opening 322 may comprise optional removable pieces, may comprise thru holes, for example, where the removable pieces have been removed, may comprise an opening having a fitting fit therein, etc. FIG. 5 illustrates a fitment provided in opening 322. In a further embodiment, the fitment may allow gas to be introduced into the bladder 302, through opening 322. Opening 322 may be located anywhere on front panel 302 and may be provided on other panels of the bladder 300. In other embodiments, the front panel 302 may have any other fixture or means for permitting gas (or a mixture of gasses such as air, or fluid, liquid, etc.) to be introduced into the bladder 300, such as a tube into a chimney, a quick connect, overlapping tubes, mating tubes, or any other suitable structure.

As shown in FIG. 12, bladder 300 may be attached to the liner 1. As stated above, the bladder 300 and liner 1 may have abutting panels thereby forming a shared common panel. In other embodiments, the bladder 300 may be external to the liner 1 and have no abutting or common panels. As illustrated in FIG. 12, bladder 300 may be attached to liner 1 by perimeter seals, such as seals 220, 222, 224, 226, 228, and 230. Alternatively, any number of seals may be used as well as any type. Also, when bladder 300 shares a common panel with liner 1, no seals or means of attachment may be necessary. Although circular seals have been described in conjunction with the bladder 100 and perimeter seals have been described in conjunction with the bladder 300, it is recognized that either type of seals, or any other suitable type of seal, may be used in conjunction with either type of bladder, or any other suitable bladder.

In this example, seals 220, 222, 224, and 226 may attach front panel 302 and rear panel 330 of bladder 300 to rear panel 6 of liner 1 at or near seals 25 and 26. Furthermore, seals 228 and 230 may attach front panel 302 and rear panel 330 of bladder 300 to front panel 4 of liner 1 at or near seals 23 and 24. Although the seals for the liner 1 and bladder 300 are illustrated by single lines, it is to be understood that the seals may vary in width and, for example, may extend out to the edges of the various portions and panels. Furthermore, the bladder 300 may be sealed to the liner 1 by continuous seals along edges 316 and 328 or by separated seals, as shown in FIGS. 12-16. In some embodiments, the seals may each be from about 5 inches to about 15 inches in length, preferably from about 8 inches to about 10 inches in length. In other embodiments, the seals may be of any suitable length.

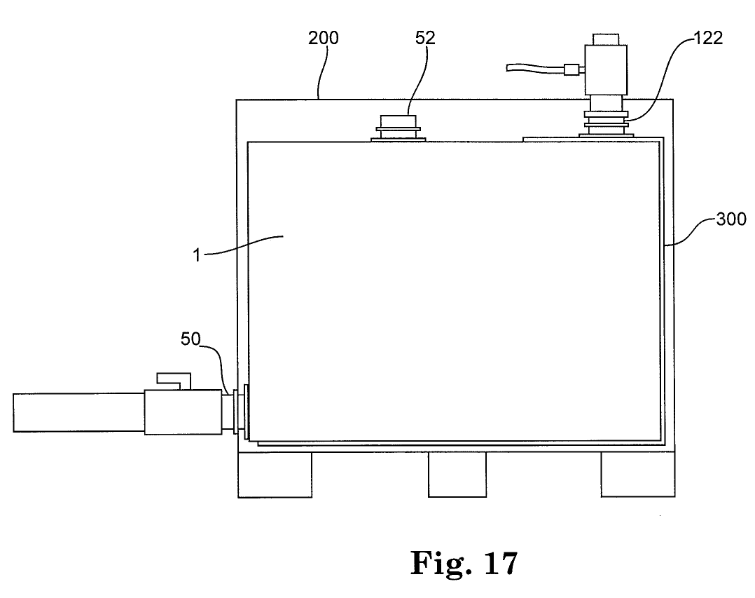

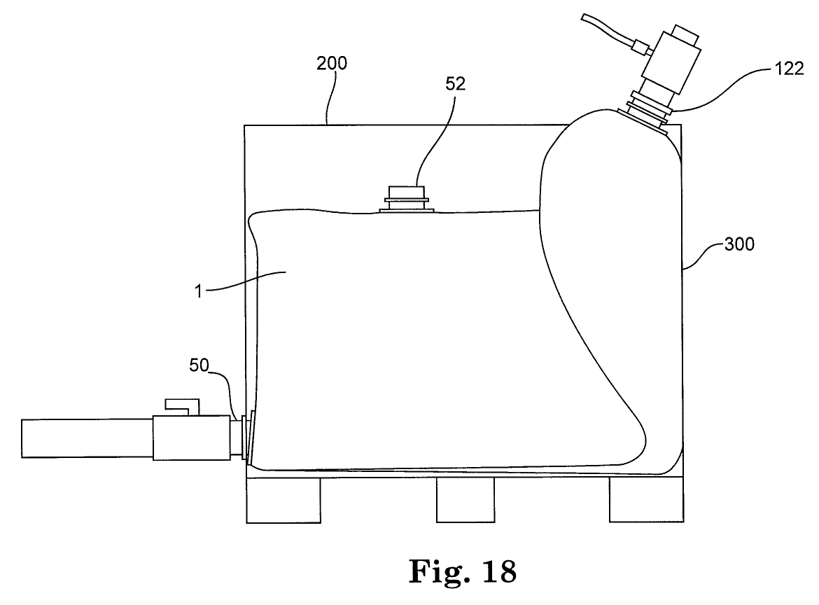

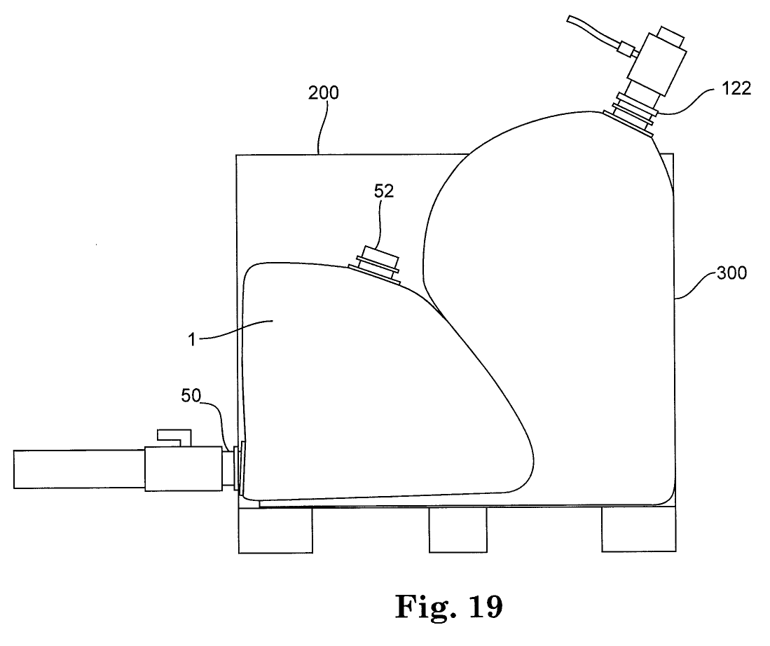

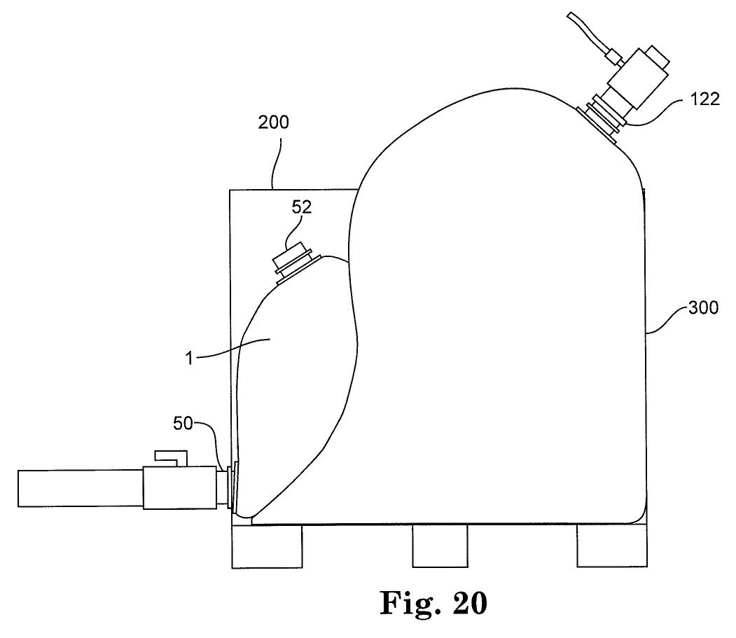

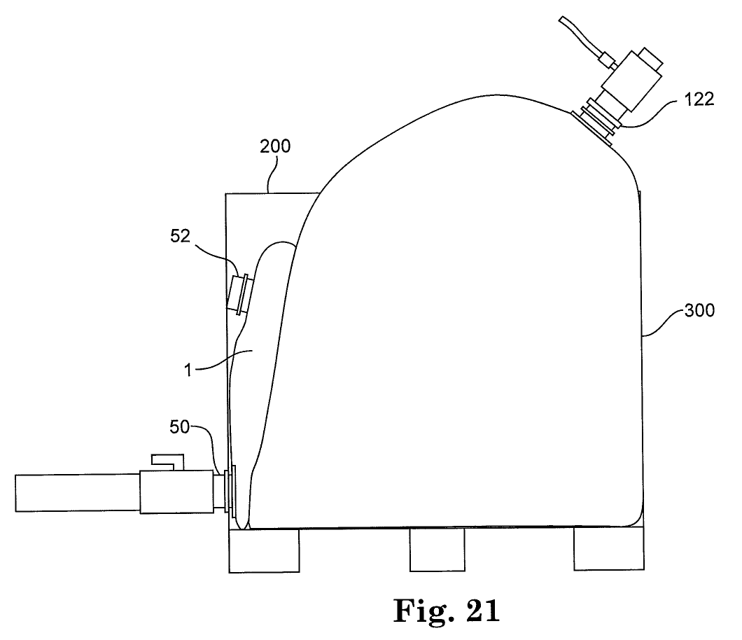

For a discussion of how the bladder may operate, reference is now made to FIGS. 17-21. Although bladder 300 is referenced during the discussion of how the bladder may operate, any suitable bladder, including the bladder 300, may be used. FIGS. 17-21 are side views of a liner 1 and a bladder 300 in a box 200. The use of the box 200 in this context is for illustration purposes only, and the bladder 300 can operate as intended without the use of the box 200. In some embodiments wherein the bladder 300 and liner 1 are contained in a box 200, the bladder 300 need not be sealed to the liner. In other embodiments, the bladder 300 may be sealed to the liner, as previously described. As shown in FIGS. 17-21, the bladder 300 may receive gas (or a mixture of gasses such as air, or fluid, liquid, etc.) through the fitment 322. The gas may inflate the area between the front portion 302, rear portion 330. In a case where the bladder 100 is used, this may additionally cause the folds 106, 104 of side portion 132, 160 to further separate and billow out. As the amount of gas inserted into bladder 300 increases, the bladder 300 may expand forcing the contents of liner 1 to be discharged through drain fitment 50.

In the example shown in FIGS. 17-21 the bladder 300 may cover the bottom panel of the liner 1 in box 200. As the bladder 300 inflates, it may elevate the rear of the liner 1 and may compress the liner 1 against the box 200. The elevation caused by covering the bottom panel of the liner 1 may be especially advantageous for high viscous materials that tend to remain on the bottom of the liner 1 without the elevation. In embodiments without the bottom panel of the liner 1 being elevated, the liner 1 may still be compressed by the expansion of the bladder 300 and the contents may be forced through the drain fitment 50 and out of the liner 1.

In the examples illustrated in FIGS. 5-16 the bladder 300 may not have a common panel with liner 1 (though the bladder 300 could share a common panel as discussed above). The lack of a common panel may protect the contents of the liner 1 in case the bladder 300 is over-inflated and breaks due to pressure. Once the contents of liner 1 have been discharged through drain fitment 50, the bladder 300 may be deflated and both the liner 1 and bladder 300 can be removed from box 200, if desired.

Although the invention has been described with reference to embodiments, persons skilled in the art will recognize that changes may be made in form and detail without departing from the spirit and scope of the invention. All directional references (e.g., rear, front, side, top, bottom) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

We claim:

1. A method of discharging the contents of a liner having portions, the method comprising:
providing a bladder that is attached to at least one of the portions of the liner, wherein the bladder has an opening for inflating the bladder; and
inflating the bladder through the opening, wherein as the bladder inflates the bladder compresses the liner and the contents of the liner are discharged through an opening in the liner.

2. The method of claim 1, wherein the at least one of the portions that the bladder is attached to is the bottom portion of the liner.

3. The method of claim 1, wherein the opening in the bladder comprises a fitting.

4. A bladder for discharging the contents of a liner having panels, the bladder comprising:
a front panel having a top end, a bottom end, and first and second longitudinal ends;
a rear panel having a top end, a bottom end, and first and second longitudinal ends;
a first side panel having a top end, a bottom end, and first and second longitudinal ends;
a second side panel having a top end, a bottom end, and first and second longitudinal ends;
a first seal joining the first side panel to the front and rear panels near the top ends of the first side panel and front and rear panels and joining the second side panel to the front and rear panels near the top ends of the second side panel and front and rear panels;
a second seal joining the first side panel to the front and rear panels near the bottom ends of the first side panel and front and rear panels and joining the second side panel to the front and rear panels near the bottom ends of the second side panel and front and rear panels;
a third seal joining the first side panel to the front panel near the first longitudinal end of the first side panel and the first longitudinal end of the front panel;
a fourth seal joining the first side panel to the rear panel near the second longitudinal end of the first side panel and the first longitudinal end of the rear panel;
a fifth seal joining the second side panel to the front panel near the first longitudinal end of the second side panel and the second longitudinal end of the front panel;
a sixth seal joining the second side panel to the rear panel near the second longitudinal end of the second side panel and the second longitudinal end of the rear panel;
a seventh seal joining the one of the panels of the bladder to one of the panels of the liner; and
an opening on at least one of the panels;
wherein the bladder is adapted to receive gas through the opening on at least one of the panels and inflate causing the liner to be compressed and discharge the contained contents.

5. A bladder for discharging the contents of a liner having panels, the bladder comprising:
a front panel having a top end, a bottom end, and first and second longitudinal ends;
a rear panel having a top end, a bottom end, and first and second longitudinal ends;
a first seal joining the front panel to the rear panel near the top ends of the front panel and the rear panel;
a second seal joining the front panel to the rear panel near the bottom ends of the front panel and the rear panel;
a third seal joining the front panel to the rear panel near the first longitudinal ends of the front panel and the rear panel;
a fourth seal joining the front panel to the rear panel near the second longitudinal ends of the front panel and the rear panel; and
an opening on at least one of the panels;
wherein the bladder is adapted to receive gas through the opening on at least one of the panels and inflate causing the liner to be compressed and discharge the contained contents.

6. The bladder of claim 5, wherein the bladder is sealed to the liner.

7. The bladder of claim 6, wherein the bladder is sealed to the liner using seals around the perimeter of an inflatable area of the bladder.

8. The bladder of claim 5, wherein the opening comprises a fitting.

9. A system for shipping and discharging contents, the system comprising:
a liner including:
a front portion, a rear portion, and first and second side portions, wherein the front, rear, and first and second side portions are sealed together to form a top panel, a bottom panel, a front panel, a rear panel, and two gusseted side panels;
at least one opening being provided on one of the front portion, the rear portion,
the first side portion, or the second side portion;
a bladder including:
a front panel having a top end, a bottom end, and first and second longitudinal ends;
a rear panel, having a top end, a bottom end, and first and second longitudinal ends;
a first seal joining the front panel to the rear panel near the top ends of the front and rear panels;
a second seal joining the front panel to the rear panel near the bottom ends of the front and rear panels; and
at least one third seal joining the bladder to the liner.

10. The system of claim 9, wherein the bladder further comprises:
a first side panel having a top end, a bottom end, and first and second longitudinal ends;
a second side panel having a top end, a bottom end, and first and second longitudinal ends;
a fourth seal joining the first side panel to the front panel near the first longitudinal end of the first side panel and the first longitudinal end of the front panel;
a fifth seal joining the first side panel to the rear panel near the second longitudinal end of the first side panel and the first longitudinal end of the rear panel;
a sixth seal joining the second side panel to the front panel near the first longitudinal end of the second side panel and the second longitudinal end of the front panel; and
a seventh seal joining the second side panel to the rear panel near the second longitudinal end of the second side panel and the second longitudinal end of the rear panel;
wherein the first seal further joins the first side panel to the front and rear panels near the top ends of the first side panel and front and rear panels and joining the second side panel to the front and rear panels near the top ends of the second side panel and front and rear panels; and
the second seal further joins the first side panel to the front and rear panels near the bottom ends of the first side panel and front and rear panels and joining the second side panel to the front and rear panels near the bottom ends of the second side panel and front and rear panels.

11. The system of claim 9, wherein the bladder further includes a fitting on at least one of the panels.

12. The system of claim 9, further including a container that is adapted to contain the liner and the bladder.

13. The system of claim 9, wherein a portion of the bladder covers a portion of the bottom panel of the liner.

14. A system for containing and discharging contents, the system comprising:
a liner adapted to receive contents;
a bladder affixed to the liner and adapted to be inflated, wherein as the bladder is inflated the bladder compresses the liner, and the contents of the liner are discharged through an opening in the liner.

15. The system of claim 14, wherein the bladder is attached to the bottom of the liner, and as the bladder inflates, a portion of the liner is elevated.

16. The device of claim 14, wherein the liner is a pillow liner.

17. The device of claim 14, wherein the liner is a six-sided flexible liner.

18. A system for shipping and discharging contents, the system comprising:
a liner adapted to receive contents;
at least two portions sealed together and adapted to be inflated, wherein the at least two portions are attached to the liner and are external to the liner.

19. The system of claim 18, wherein the liner is a pillow liner.

20. The system of claim 18, wherein the liner is a six-sided flexible liner.

21. The system of claim 18, wherein the at least two portions include a fitting that is adapted to receive gas.

22. The system of claim 18, wherein the at least two portions are attached to the bottom of the liner.

23. The system of claim 22, wherein the at least two portions are further attached to the top of the liner.

24. The system of claim 18, wherein the liner includes a fitting.
